(19) United States
(12) Patent Application Publication
(10) Pub. No.: US 2008/0254190 A1
(43) Pub. Date: Oct. 16, 2008

(54) Extraction of theaflavins

(75) Inventors: Shovan Ganguli, Vlaardingen (NL); Yogesh Prabhakarrao Mehare, Bangalore (IN); Ashim Mullick, Bangalore (IN)

Correspondence Address: UNILEVER PATENT GROUP, 800 SYLVAN AVENUE, AG West S. Wing, ENGLEWOOD CLIFFS, NJ, 07632-3100, US

(73) Assignee: Conopco, Inc. d/b/a Unilever

(21) Appl. No.: 12/082,260

(22) Filed: Apr. 10, 2008

(30) Foreign Application Priority Data
Apr. 12, 2007 (IN) 0722/MUM/2007
May 18, 2007 (EP) 07108479

(51) Int. Cl. A23F 3/30

(52) U.S. Cl. 426/597

(57) ABSTRACT

The present invention provides a process for extraction of theaflavins from tea including the step of contacting tea with an aqueous solution of urea.

### TECHNICAL FIELD OF INVENTION

The invention relates to an improved process for extraction of theaflavins from tea.

### BACKGROUND OF THE INVENTION

Two of the popular products from tea are black tea and green tea. Generally, to prepare black tea, fresh leaves of the plant Camellia sinensis are withered (a process to allow the plucked tea leaves to lose moisture and bring about chemical/biochemical changes especially in aroma), macerated, fermented (in which process enzymes in the tea leaf use atmospheric oxygen to oxidise various substrates to produce coloured products) and then dried at high temperatures (to stop the enzyme activities). Green tea is produced by the same process as used for manufacture of black tea except for the step of exposing the tea leaves to the fermentation step. Partial fermentation is used to produce intermediate-type teas known as “oolong” tea.

Theaflavins are polyphenols produced during production of tea. Most theaflavins are known to be antioxidants. Therefore there is great interest in the food, beverages and health-care industries in production and incorporation of theaflavins in various products.

Tea leaf, when picked from the tea plant contains polyphenols known as catechins. These catechins are colourless compounds. The four major catechins in tea leaf are epicatechin (EC), epigallocatechin (EGC) epicatechin-3-gallate (ECG) and epigallocatechin-3-gallate (EGCG). Theaflavins are produced during the oxidative fermentation of leaf tea to produce black tea. The above named catechins undergo oxidative biotransformations into dimeric compounds known as theaflavins (TFs) and higher molecular weight compounds known as thearubigins (TRs). The structures of the TFs are well known and the four main theaflavins are known as theaflavin (TF1), theaflavin-3-monogallate (TF2), theaflavin-3′-monogallate (TF3) and theaflavin-3-3′-digallate, (TF4) and conform to general formula (1):

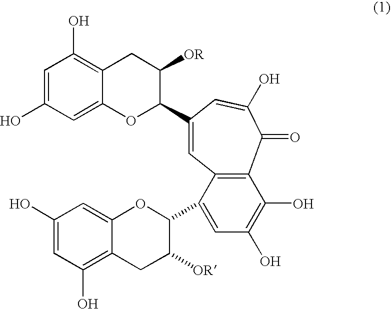

wherein R and R′ are independently selected from H and G, and wherein G is derived from gallic acid and has formula (2):

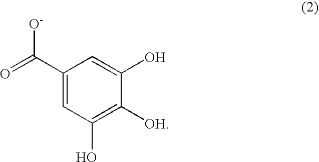

In particular, the four theaflavins have formula (1) where:

### for TF1 R=R′=H;

### for TF2 R=G, R′=H;

### for TF3 R=H, R′=G; and

### for TF4 R=R′=G.

The characteristic orange and brown colour of brewed black tea is due to the presence of the TFs and the TRs. They also give astringency and body to the brewed tea. TRs are larger in size and darker in colour than TFs.

Tea is a popular, low-cost beverage that is consumed throughout the world. Its consumption in the Indian subcontinent is particularly high. Plain brewed black tea, in general, is in itself known to be healthy to drink. In spite of this, due to the high per-capita consumption of tea, throughout the world, there has been many attempts to make tea healthier. One way to achieve this has been to increase the amount of theaflavins in tea. One approach to do this has been to manipulate the tea oxidation process to enhance production of theaflavins. Another approach has been to extract theaflavins from good quality black tea, or lower quality tea products like tea fibre, tea powder etc and add-back the extracted theaflavins in to black tea to prepare premium quality tea.

U.S. Pat. No. 6,113,965 (Lipton, 2000) discloses a method for making a theaflavin-rich cold water soluble tea product comprising the steps of treating a slurry of green leaf tea with tannase, fermenting said slurry, deleafing said slurry to give a theaflavin-rich tea liquor and spent dhool, drying said tea liquor to yield a liquor-derived theaflavin-rich cold water soluble tea powder, performing one or more solvent extractions of said spent dhool, drying said extract or extractions to form a dhool-derived theaflavin-rich powder or powders, and mixing said liquor-derived theaflavin-rich cold water soluble tea powder with said dhool-derived theaflavin-rich powder or powders to yield the theaflavin-rich cold water soluble tea product

U.S. Pat. No. 5,532,012 (Lipton, 1996) discloses a method for producing a mixture of theaflavins closely approximating the natural mixture of said theaflavins existing in tea cream comprising: (a) obtaining said tea cream from black tea; (b) solubilizing said tea cream in water at a temperature of about 140° F. to 220° F. and a concentration of about 15 to 40% by weight of said tea cream to form a tea cream solution; and (c) mixing said tea cream solution with an organic liquid to form a mixed liquid solution, said organic liquid having a boiling point less than water, being miscible in all proportions with water and having a hydrophobicity such that when mixed with water and theaflavins from said solubilized tea cream, the theaflavins preferentially extract into said mixed liquid to solubilize said tea cream theaflavins, said organic liquid being present in an amount of about 1 part by weight to 9 parts water by weight in said mixed liquid to about 9 parts by weight of organic liquid to 1 part by weight of water, in said mixed liquid;

The present inventors have also been working on the problem of providing theaflavin enhanced tea. We have found that there are certain problems with known methods of the prior art, with getting high extraction yield or problems in the separations processes. Using water at about 25° C., for extraction of theaflavins from tea, the maximum yield that could be obtained was of the order of about 5-8%. When hot water (of about 80-85° C.) was used, about 30-40% of the theaflavins could be extracted and the high temperatures employed tended to degrade the theaflavins upon prolonged exposure. When organic solvents like alcohols were used, almost 100% of the theaflavins could be extracted but there were certain downstream separation problems. The theaflavins are highly soluble in solvents like alcohols and ethyl acetate and therefore separating the TFs from the alcohol using well known solvent extraction techniques using solvents like ethyl acetate gave poor overall extraction efficiencies. The present inventors therefore embarked on developing a process for enhancing the extraction of TFs from tea.

It is thus an object of the present invention to provide for a process to enhance the yield of extraction of theaflavins from tea.

It is another object of the present invention to provide for a process to enhance the extraction yield of theaflavins from tea using a simple, economical and easy-to-scale-up process.

### SUMMARY OF THE INVENTION

According to the present invention there is provided a process for extraction of theaflavins from tea including the step of contacting tea with an aqueous solution of urea.

The invention, its advantages and other aspects will now be explained in greater detail, in the following detailed description.

### DETAILED DESCRIPTION

The present invention relates to an improved process for extraction of theaflavins from tea using a step which is a simple aqueous extraction process.

“Tea” for the purposes of the present invention means leaf material from Camellia sinensis var. sinensis and/or Camellia sinensis var. assamica which comprises theaflavins. Suitable raw material for the process of the invention is black tea or oolong tea. Black tea includes good quality tea as well as off-grades produced during black tea manufacture. The most preferred source for extraction of theaflavins is black tea.

The tea that is produced by complete fermentation process and that appears black/brown in color is referred to as black tea. The majority of tea produced is of this kind. Black tea manufacturing technology essentially involves disruption of the cellular integrity of tea shoots, thereby enabling the mixing of substrates (polyphenols) and the enzymes (polyphenol oxidases). This results in the initiation of a series of biochemical and chemical reactions with the uptake of atmospheric oxygen and formation of oxidized polyphenolic compounds that are characteristic of tea along with volatile flavor compounds that impart characteristic aroma to tea.

When the fermentation is carried out partially, the resultant teas are referred to as Oolong tea.

The invention relates to a process for extraction of theaflavins from tea including the step of contacting tea with an aqueous solution of urea. Also within the scope of the invention is a process of contacting solid tea with solid urea and adding water in sufficient amounts to solubilise at least some of the urea present. Preferably the urea is present in the aqueous solution in an amount in the range of 2 to 6 moles/litre. Although urea concentrations as high as 7 moles/litre can be used, the present inventors have found that there is not much further increase in the extraction efficiency above a concentration of 6 moles/litre. Thus the optimum concentration of urea in the aqueous solution is about 6 moles/litre.

The process of the invention is preferably carried out in the presence of sufficient water to form a slurry of tea in urea solution. Thus a preferred weight ratio of the aqueous solution of urea to tea is in the range of 2:1 to 100:1 more preferably 8:1 to 100:1.

The extraction of theaflavins from tea using the process of the invention is preferably performed at a temperature of from 20 to 50° C.

The extraction is usually carried out at a pH of about 7.5-8, however it may be carried out at a pH of the aqueous solution of urea in the range of 4 to 9. Good extraction of theaflavins is obtained when the tea is contacted with the aqueous solution of urea for a period of time in the range of 5 to 120 minutes, more preferably from 60 to 120 minutes.

Once the theaflavins have been extracted into the urea solution, the theaflavins therein can be separated by any known method. Suitable methods include, solvent extraction, membrane separations, precipitation, crystallisation and/or adsorption using polymeric adsorbents, silica, derivatized silica etc. The most preferred method is extraction using ethyl acetate or solvents with similar polarity.

### EXAMPLES

The following examples are presented by way of illustrations and they do not limit the scope of the invention in any way.

Source and origin of the ingredients used in developing the invention

| | | Source and |
|---|---|---|
| | | geographical origin of |
| Ingredient | Form of ingredient | ingredient |
| Tea | Brooke Bond Red Label ™ Tea | Hindustan Lever Limited, |
| | (black tea) | India |

### Comparative Example A and B

### Effect of Using Water at Various Temperatures at Various Extraction Times

Extraction of theaflavins was carried out using water at various temperature conditions. Samples of the theaflavin extract were taken at various extraction times. The extraction was carried out at a condition where weight ratio of tea to water was 1:50. The method to determine amount of theaflavins in an aqueous solution and the amount of theaflavins in tea is described below. The amount of theaflavins extracted as a percentage of total theaflavins in the tea was calculated and the data is summarized in Table-1.

The amount of theaflavin in an extract is determined by HPLC analysis after suitable dilution of the sample with a stabilizing solution (0.5 g/L ascorbic acid, 0.5 g/L EDTA, 10% v/v acetonitrile and 90% v/v water). To determine the total theaflavin level present in black tea, a method in which quantitative extraction of theaflavin occurs is used which comprises of extracting the tea with 70% methanol for 10 min at water to leaf ratio of 50:1 and temperature of 80-85° C.

Quantification of theaflavins in extraction media involves the analysis of two samples: a) the extraction medium and b) the spent tea re-extracted with 70% methanol as described above. As the initial total level of theaflavins in tea is known, the measurement of theaflavins in the extract and in the spent tea enables complete mass balance. This also enables quantification of any theaflavin degradation during the extraction process employed.

The theaflavin level is the sum of the level of the four theaflavins (TF1, TF2, TF3, TF4) as determined by HPLC. The amount of the four theaflavins in a sample is analysed by HPLC using an octadecylsilica (C18) column (Nova-pak™ ex. Waters, 3.9 mm i.d.×150 mm) with detection at 380 nm, column temperature of 40° C., injection volume of 20 μL and flow rate of 1 mL/min. The mobile phases for theaflavin analysis were 2% (v/v) acetic acid in water (mobile phase A) and acetonitirile (mobile phase B). A gradient from 8% B to 69% B over 50 min was used to separate the four theaflavins following which the column was equilibrated with 8% buffer A for 5 min. Pure theaflavins were used as standards for quantification.

TABLE 1

| | | | | % |
|---|---|---|---|---|
| | | | | theaflavins |
| | Extraction | % theaflavins | % theaflavins | extracted, |
| Comparative | Temperature, | extracted, | extracted, | time = |
| Example | ° C. | time = 5 mins | time = 20 mins | 40 mins |
| A | 25 | 4.8 | 5.4 | 5.8 |
| B | 85 | 30.1 | 36.1 | 33.8 |

The data in Table-1 indicates that no more than about 36% of the theaflavins can be extracted into water even at a temperature as high as 85° C.

### Examples 1 to 3

### Effect of Using Aqueous Solution of Urea at Various Temperatures at Various Extraction Times

Extraction of theaflavins was carried out using 6 molar aqueous urea at various temperature conditions. Samples of the theaflavin extract were taken at various extraction times. The extraction was carried out at a condition where weight ratio of tea to water was 1:50. The amount of theaflavins extracted as a percentage of total theaflavins in the tea was calculated and the data is summarized in Table-2.

TABLE 2

| | Extraction | % theaflavins | % theaflavins | % theaflavins |
|---|---|---|---|---|
| | Temp., | extracted, | extracted, | extracted, |
| Example | ° C. | time = 10 mins | time = 20 mins | time = 40 mins |
| 1 | 25 | 54.4 | 71.8 | 76.1 |
| 2 | 40 | 65.8 | 72.9 | 80.4 |
| 3 | 60 | 64.5 | 63.1 | 55.5 |

The data in Table-2, read along with data in Table-1, indicates that much higher amounts of theaflavins can be extracted using aqueous solutions of urea as compared to using water alone.

### Examples 4 to 6

### Effect of Concentration of Urea Used for Extraction

Extraction of theaflavins was carried out using various concentrations of aqueous urea (2 Molar to 7 Molar). The extraction was carried out for 60 minutes at 25° C. with the weight ratio of tea to water at 1:50. The amount of theaflavins extracted as a percentage of total theaflavins in the tea was calculated and the data is summarized in Table-3.

TABLE 3

| Example. | Urea Conc, | % theaflavins extracted, |
|---|---|---|
| 4 | 2 M | 38.1 |
| 5 | 5 M | 52.1 |
| 1 | 6 M | 76.1 |
| 6 | 7 M | 80.0 |

The data in Table-3 indicates that very good extraction of theaflavins at 25° C. is obtained using various concentrations of urea with high extraction amount obtained at about 6 M to 7 M urea concentration.

### Example-1A to 1D

### Amount of Various Types of Theaflavins Extracted

Extraction of theaflavins was carried out with 6 M urea for 60 minutes at 25° C. with the weight ratio of tea to water at 1:50. The amount of the various theaflavins (TF1 to TF4) extracted as a percentage of total individual theaflavins (TF1 to TF4) in the tea was determined and the data is summarized in Table-4.

TABLE 4

| Example. | Type of Theaflavin | % theaflavins extracted, |
|---|---|---|
| 1A | TF1 | 78.9 |
| 1B | TF2 | 78.6 |
| 1C | TF3 | 72.0 |
| 1D | TF4 | 73.0 |
| 1 | Total | 76.1 |

The data in Table-4 indicates that all the theaflavins are extracted in high amounts by the method of the invention.

### Examples 7 to 9

### Effect of Tea to Aqueous Solution (L/W) Ratio

Extraction of theaflavins was carried out with 6 M urea for 90 minutes at 25° C. at various weight ratios (LAN ratio) of tea to aqueous solution of urea (from 1:10 to 1:50). The amount of total theaflavins extracted as a percentage of total theaflavins in tea was calculated and the data is summarized in Table-5.

TABLE 5

| Example. | L/W ratio | % theaflavins extracted, |
|---|---|---|
| 7 | 1:10 | 48.3 |
| 8 | 1:30 | 69.8 |
| 9 | 1:50 | 81.1 |

The data in Table-5 indicates that high amounts of theaflavins can be extracted over a wide range of L/W conditions.

### Comparative Example C & D, Example-10

### Yield of Solid Theaflavins Extracted as % of Tea

### Comparative Example C

Theaflavins were extracted from tea using a 50% ethanol in water mixture at a temperature of 80° C. for 15 minutes at a L/W ratio of 1:50 (first step). The amount of theaflavins extracted into the ethanol-water mixture as a percentage of theaflavins in tea was determined. Thereafter the theaflavins in the ethanolic solution was extracted using ethyl acetate. The results of the extraction efficiency at each stage to form the final solids are summarized in Table-6.

### Comparative Example D

Theaflavins were extracted from tea using ethylacetate. The result is shown in Table-6

### Example-10

Similar extraction was carried out using first a 6 M urea solution at 25° C. for 90 minutes at an LAN ratio of 1:50 (first step). The amount of theaflavins extracted into the urea solution as a percentage of theaflavins in tea was determined. Thereafter the theaflavins in the urea solution was extracted using ethyl acetate. The results of the extraction efficiency at each stage to form the final solids are summarized in Table-6.

TABLE 6

| | % | |
|---|---|---|
| | theaflavins | |
| | extracted, | |
| | in first | |
| Example | step | theaflavins extracted as solids as % in tea |
| Comp | 92.7 | Not possible to isolate theaflavins since ethyl |
| Example-C | | acetate forms single phase mixture with |
| | | ethanol-water mixture |
| Comp. | — | No theaflavins could be isolated when directly |
| Example-D | | extracted with Ethyl acetate |
| Example- | 81 | 50 |
| 10 | | |

The data in Table-6 indicates that it is possible to isolate a high percentage of theaflavins into solid form using the process of the invention (Example-10). Compared to this, theaflavins are extracted to a high extent into ethanolic water solution but it is difficult to isolate theaflavins into solids using known downstream processing methods.

The invention thus provides for a process that yields enhanced extraction of theaflavins from tea using a simple, economical and easy-to-scale-up process.

1. A process for extraction of theaflavins from tea including the step of contacting tea with an aqueous solution of urea.

2. A process as claimed in claim 1 wherein said tea is black tea or oolong tea.

3. A process as claimed in claim 1 wherein the concentration of urea in the aqueous solution is from 2 to 6 M.

4. A process as claimed in claim 1 wherein the ratio of the aqueous solution to tea is in the range of 2:1 to 100:1 parts by weight.

5. A process as claimed in claim 1 wherein the temperature of the aqueous solution is from 20° C. to 50° C.

6. A process as claimed in claim 1 wherein pH of the aqueous solution is from 4 to 9.

7. A process as claimed in claim 1 wherein the tea is contacted with the aqueous solution for from 5 to 120 minutes.

8. A process as claimed in claim 1 wherein theaflavins in the aqueous solution of urea are separated using extraction with ethyl acetate.

9. Use of an aqueous solution of urea for extraction of theaflavins from tea.
